(19) United States
(12) Patent Application Publication
(10) Pub. No.: US 2006/0230629 A1
(43) Pub. Date: Oct. 19, 2006

(54) Wearable disposable dryer with carrying strap and stowage accessory

(76) Inventors: Michael J. Arno, Clarence, NY (US); Daniel Blaszkowiak, Cheektowaga, NY (US); John A. Carlin, Buffalo, NY (US)

Correspondence Address: WALTER W. DUFT;LAW OFFICES OF WALTER W. DUFT, 8616 MAIN ST, SUITE 2, WILLIAMSVILLE, NY, 14221, US

(21) Appl. No.: 11/107,332

(22) Filed: Apr. 16, 2005

(51) Int. Cl. F26B 21/06; F26B 19/00

(52) U.S. Cl. 34/80; 34/201

(57) ABSTRACT

A wearable, disposable dryer for point-of-use installation in an air/gas line delivering compressed air or gas to an air/gas-driven tool. The dryer includes a main body, a drying composition substantially filling the main body, inlet and outlet connectors, a carrying strap and a wall mount holder that provides a stowage accessory. The strap can be attached to the inlet and outlet connectors, each of which can be provided with a strap mounting portion. According to a method of use, the dryer is attached to air/gas lines and the strap is placed over a user's shoulder so that the dryer can be worn while delivering dried compressed air or gas to a tool. A dryness indicator may be provided as either a site glass or by virtue of a portion of the main body being transparent or translucent and a dryness indicating material in the dryer being viewable therethrough. The wall mount holder allows a user to stow the dryer (with the air/gas lines connected thereto) when the dryer is not in use, or during use in the event the user does not wish to wear the unit.

### BACKGROUND OF THE INVENTION

1. Field of the Invention

The present invention relates to the field of compressed air and gas systems, and more particularly to filtering and drying equipment for filtering and removing moisture from compressed air and gas delivered to air/gas-driven tools.

2. Description of Prior Art

Typical compressed air or gas produced by a compressor apparatus is saturated with 50% to 100% relative humidity, and also contains contaminants such as dirt, dust, oil, line debris and other matter. Filters and traps remove liquid water and other contaminants but do nothing to eliminate the 50% to 100% moisture vapor still remaining in the compressed air or gas. The removal of this moisture vapor requires that an air/gas dryer system be used, such as a refrigerated dryer or an adsorbent type of dryer. Such systems are generally very effective, the latter being typically capable of drying compressed air or gas to below-zero dew point levels. However, even basic dryer systems are relatively expensive, can be difficult to install due to their large and bulky nature, and require regular maintenance to ensure proper operation. Individuals and other entities with limited financial resources, or who do not use compressed air/gas on a regular basis, may elect not to install drying equipment in their compressed air/gas systems, and instead use compressed air or gas that has not been treated to remove moisture vapor. Even if a dryer system is installed, there is no guarantee that the compressed air or gas will have the desired dryness by the time it arrives through an air/gas feed system to a downstream point of use. Compressed air lines, various fitting and regulation devices, or improper operation of the dryer system all represent sources of residual moisture vapor in the air/gas feed system. This means that compressed air or gas that has been moisture-treated may not have the desired dryness characteristics by the time it goes into use as an application. This can cause problems in applications such as paint booth operations where compressed air or gas is used as a propellant to atomize and expel paint from a paint gun. If moisture-laden ambient air is delivered through the air/gas line, it will feed through the paint gun, and may cause unwanted fouling that results in a bad and unacceptable paint job.

It is to solving the foregoing problems that the present invention is directed. What is needed is an improved air/gas dryer that is easy to install and use, simple and inexpensive, and requires no maintenance. The dryer should be suitable for use as the primary or sole air/gas moisture vapor treatment apparatus in a compressed air/gas system, but should also be usable with existing dryer systems. Adding a filtering function to such a dryer would be further desirable.

### SUMMARY OF THE INVENTION

The foregoing problems are solved and an advance in the art is achieved by a wearable, disposable point-of-use dryer apparatus for installation in an air/gas line delivering compressed air or gas to an air/gas-driven tool. The dryer includes a main body, a drying composition substantially filling the main body, inlet and outlet connectors on the main body, and a carrying strap for wearing the dryer during use. The strap can be attached to the inlet and outlet connectors, each of which may be provided with a strap-mounting portion defined at one end thereof by a strap retention flange and at the other end by the main body. The strap may include an opening at each end adapted to engage one of the strap mounting portions.

The dryer may further include a dryness indicator implemented as either a site glass or by virtue of a portion of the main body being transparent or translucent aid a dryness indicating material in the dryer that is viewable through the transparent or translucent main body portion.

An optional wall mount holder provides a stowage accessory that is designed to releasably mount the dryer to a wall while air/gas lines are connected thereto during use (or non-use) of the dryer. The wall mount holder may include a lower base adapted to hold one end of the dryer. The base may have a slot to accommodate one of the inlet and outlet connectors. The wall mount holder may further include one or more retainer members above the base adapted to engage a medial portion of the main body. Each of the one or more retainer members may have a gap to accommodate an air/gas line when the dryer is inserted in or removed from the wall mount holder, thereby allowing the dryer to be stowed while the dryer is being used in, the event that a user does not wish to wear the unit.

The inlet and outlet connectors may be respectively disposed at first and second ends of the main body or at any other desired location. If situated at the ends of the main body, the inlet and outlet connectors may extend along a longitudinal centerline axis of the main body. Alternatively, one or both of the inlet and outlet connectors may extend transversely to the longitudinal centerline axis. The inlet and outlet connectors may be removably attached to the main body or they can be integrally formed thereon.

In another aspect of the invention, a method of use includes selecting a wearable, disposable dryer having a main body, a drying composition substantially filling the main body, inlet and outlet connectors on the main body, and a carrying strap. The method further includes, in any desired order, placing the carrying strap on a person, attaching a first air/gas hose to the air inlet connector, attaching a second air/gas hose to the air outlet connector, operating an air/gas driven tool attached to the second air/gas hose while wearing the dryer, and optionally stowing the dryer in a wall mount holder in the event a user does not wish to wear the unit.

In a further aspect of the invention, the main body of the dryer has a construction that includes a central tube and a pair of end caps. A pair of inlet and outlet connectors are mounted on the end caps, either integrally or as separate components. In either case, the connectors are formed with a filter-receiving chamber that carries a filter element. The drying composition can be introduced into the central tube after one of the end caps has been mounted thereon through the remaining open end of the tube. The second end cap can then be mounted to close the dryer. Alternatively, the drying composition could be added after the end caps have been mounted to the central tube by way of an aperture in the tube that is used to mount a sight glass, or through an opening that receives one of the inlet and outlet connectors, if the latter are separately mounted components. Many other assembly techniques may also be used.

### BRIEF DESCRIPTION OF THE DRAWINGS

The foregoing and other features and advantages of the invention will be apparent from the following more particular description of preferred embodiments of the invention, as illustrated in the accompanying Drawings in which:

FIG. 1 is a perspective view showing a wearable, disposable point-of-use dryer constructed in accordance with an exemplary embodiment of the present invention with a portion thereof broken away to illustrate a drying composition therein;

FIG. 2 is another perspective view of the dryer of FIG. 1 showing the attachment of a carrying strap thereto;

FIG. 3 is a perspective view showing the dryer of FIG. 1 being worn by a user during operation;

FIG. 4 is an exploded perspective view showing an exemplary construction of the dryer of FIG. 1;

FIG. 5A is a side elevation view showing a first exemplary configuration of an end cap portion of the dryer construction of FIG. 4 in which the inlet and outlet connectors are provided by a removable fitting;

FIG. 5B is a side elevation view showing a second exemplary configuration of an end cap portion of the dryer construction of FIG. 4 in which the inlet and outlet connectors are provided by an integral fitting;

FIG. 5C is a side elevation view showing a third exemplary configuration of an end cap portion of the dryer construction of FIG. 4 in which an integrated dryness indicator is provided by a sight glass fitting;

FIG. 5D is a side elevation view showing a fourth exemplary configuration of an end cap portion of the dryer construction of FIG. 4 in which an integrated dryness indicator is provided by virtue of the end cap being transparent or translucent;

FIG. 6 is a cross-sectional longitudinal centerline view showing the flow of compressed air or gas through the dryer construction of FIG. 4 during operation;

FIG. 7 is a perspective view showing another exemplary construction of the dryer of FIG. 1;

FIG. 8 is an exploded perspective view showing the dryer construction of FIG. 7;

FIG. 9A is a detailed exploded perspective view showing an end cap of the dryer construction of FIG. 7;

FIG. 9B is a detailed exploded perspective view showing a technique for mounting the end cap of FIG. 9A according to the dryer construction of FIG. 7;

FIG. 10A is a cross-sectional centerline view of the dryer construction of FIG. 7 during assembly;

FIG. 10B is a cross-sectional centerline view of the dryer construction of FIG. 7 following assembly;

FIG. 11 is a perspective view showing a wall mount holder that provides a stowage accessory for the dryer of FIG. 1; and

FIG. 12 is a perspective view showing the wall mount holder of FIG. 11 with the dryer of FIG. 1 mounted therein.

### DETAILED DESCRIPTION OF EXEMPLARY EMBODIMENTS

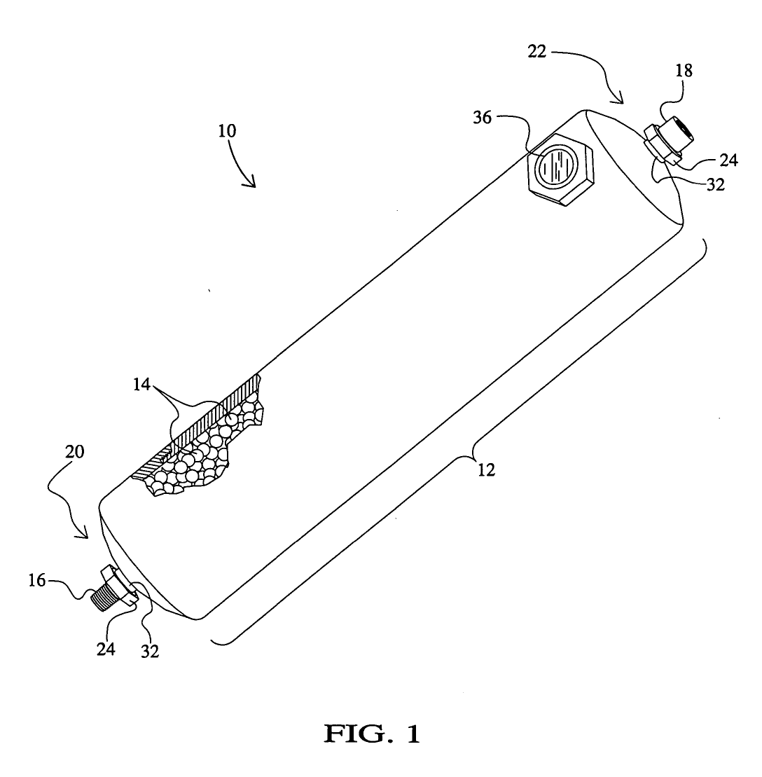

Turning now to the drawings wherein like reference numerals indicate like elements in all of the several views, FIG. 1 illustrates a wearable, disposable point-of-use dryer apparatus 10 constructed in accordance with an exemplary embodiment of the invention. The apparatus 10 includes a main body 12 made from plastic, metal or other suitable material capable of withstanding the anticipated operating pressures within the dryer 10 according to its intended use. The main body 12 has a hollow interior that is substantially filled with a drying composition 14 that may be selected from any suitable material having the required drying characteristics. Exemplary materials include but are not limited to (1) moisture adsorbing desiccants such as silica gel beads, activated alumina beads, clays and molecular sieves, and (2) moisture absorbing fibers such as cotton, paper, wood,particles or the like. Due to their superior moisture removal properties, activated alumina desiccant beads of the type commonly used in compressed air/gas drying systems represent the preferred material used for the drying composition 14.

An inlet connector 16 and an outlet connector 18 are provided on the main body 12 for coupling the dryer 10 into a compressed air/gas line (not shown in FIG. 1). The inlet connector 16 and the outlet connector 18 are shown as being respectively situated at first and second ends 20 and 22 of the main body 12, with each connector being oriented to extend along the main body's longitudinal centerline axis. It will be appreciated that the connectors 16 and 18 could be mounted at other locations, such as inwardly of the first and second ends 20 and 22 of the main body 12, and one or both of the connectors 16 and 18 could be oriented in a different direction, such as transversely to the main body's longitudinal centerline axis. Each of the connectors 16 and 18 includes a conventional thread pattern adapted to threadably engage a corresponding connector of an air/gas line. For purposes of illustration only and not by way of limitation, the inlet connector 16 is shown to have a male thread configuration and the outlet connector 18 is shown to have a female thread configuration. If desired, the thread configurations could be reversed so that the inlet connector 16 has female threads and the outlet connector 18 has male threads. Alternatively, both connectors 16 and 18 could be male-threaded or female-threaded. All such threads preferably comply with NPT (National Pipe Thread) standards. A flange 24 having a hexagonal wrench pattern can be formed on each of the connectors 16 and 18 to receive a wrench or other tool for installing the dryer 10 in a compressed air/gas system. It should be further understood that either one or both of the connectors 16 and 18 could be of the quick-connection type for greater ease of use.

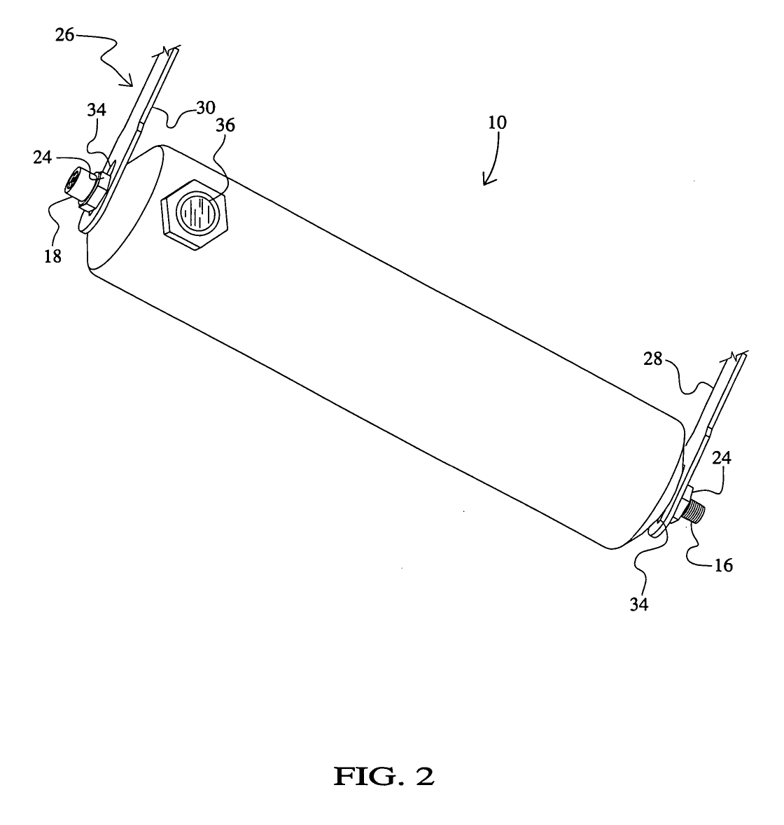

As additionally shown in FIG. 2, the dryer 10 further includes a carrying strap 26 having a first end 28 mounted to the inlet connector 16 and a second end 30 mounted to the outlet connector 18. To facilitate such mounting, each of the connectors 16 and 18 is provided with a strap mounting portion 32 (see FIG. 1) and the ends 28 and 30 of the strap 26 each include an opening 34 that fits over the strap mounting portion 32. The strap-mounting portion 32 of each connector 16 and 18 is formed as a short cylindrical post extending between the wrench-receiving flange 24 and an associated one of the ends 20/22 of the main body 12. The opening 34 in the strap ends 26 and 28 can be formed as a slit, a slot, a hole, or the like that can be manipulated over the wrench-receiving flange 24 and into position on the strap mounting portion 32.

As shown in FIGS. 1 and 2, the dryer 10 can be optionally provided with a dryness indicator 36. The dryness indicator 36 allows a user to visually check the condition of the drying composition 14 to determine when it is time to discard (or recycle) the dryer 10. Although the dryness indicator 36 is shown as having a conventional site glass construction in FIGS. 1 and 2, other dryness indicator constructions could also be used, as described in more detail below.

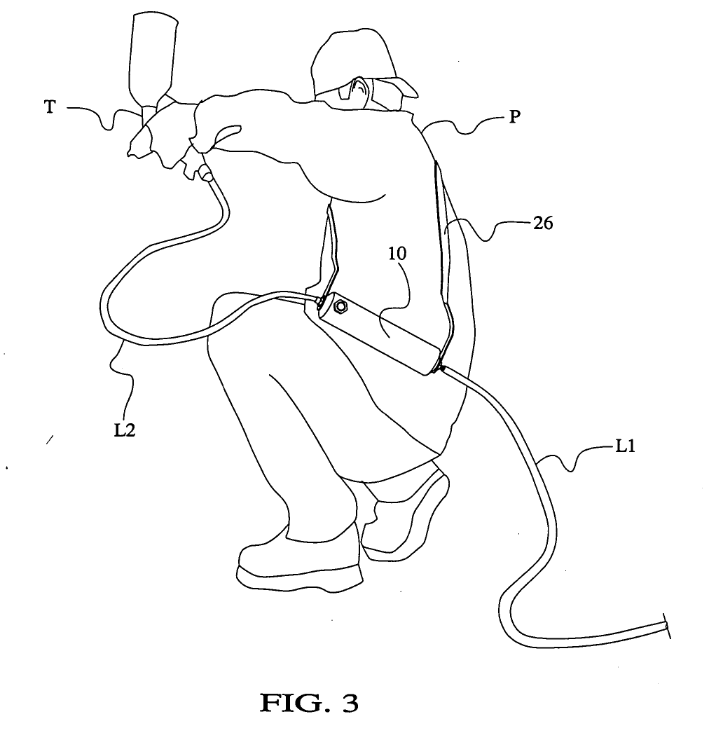

Turning now to FIG. 3, the dryer 10 is ideally suited for installation near a point-of-use, such as between a first compressed air/gas hose line “L1” extending from a compressed air/gas source (not shown) and a second compressed air/gas hose line “L2” delivering compressed air or gas to an air/gas-driven tool “T,” such as a paint gun. The dryer 10 is well suited for installation in the forgoing manner due to its compact and unobtrusive nature, and because the carrying strap 26 allows the dryer to be worn by a person “P” who can move about a work area with minimal restriction during dryer operation. To use the dryer 10, the person “P” selects the dryer and checks the dryness indicator 36 to verify that the dryer is operational. Prior to or after entering the work area, the person “P” places the carrying strap 26 over their shoulder, around their neck, around their waste, etc., according to personal preference and comfort. After attaching the first compressed air/gas hose line “L1” to the air inlet connector 16 and the second compressed air/gas hose line “L2” to the air outlet connector 16, the person “P” is ready to operate the air/gas-driven tool “T” while wearing the dryer 10. If the person “P” needs to take a break or leave the work area for some reason, he/she can either slip off the carrying strap 26 and set down the dryer 10, or disconnect the dryer from the first and second compressed air/gas hose lines “L1” and “L2” and leave the work area carrying the dryer.

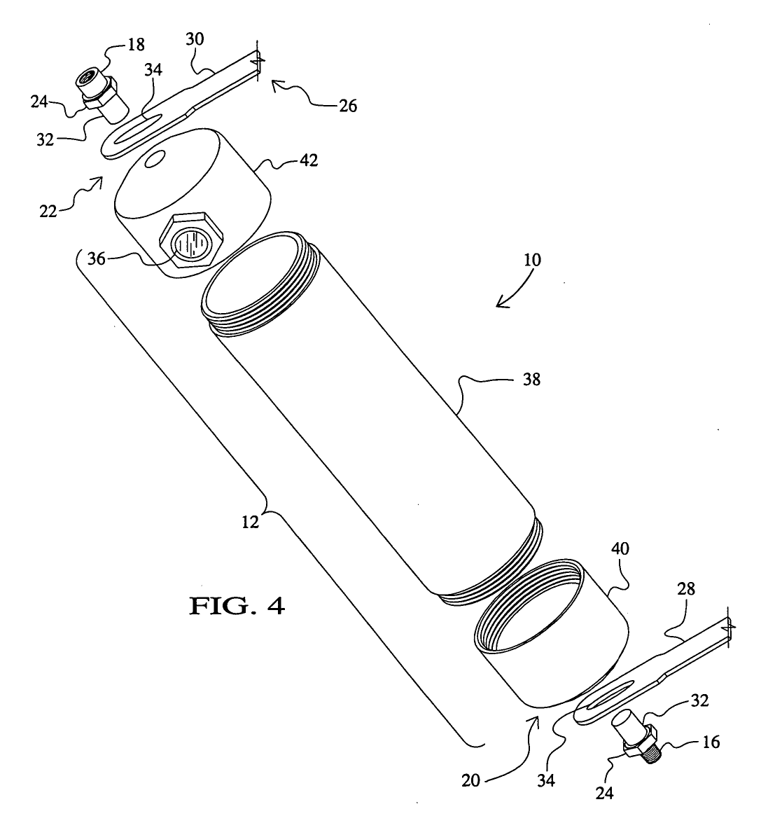

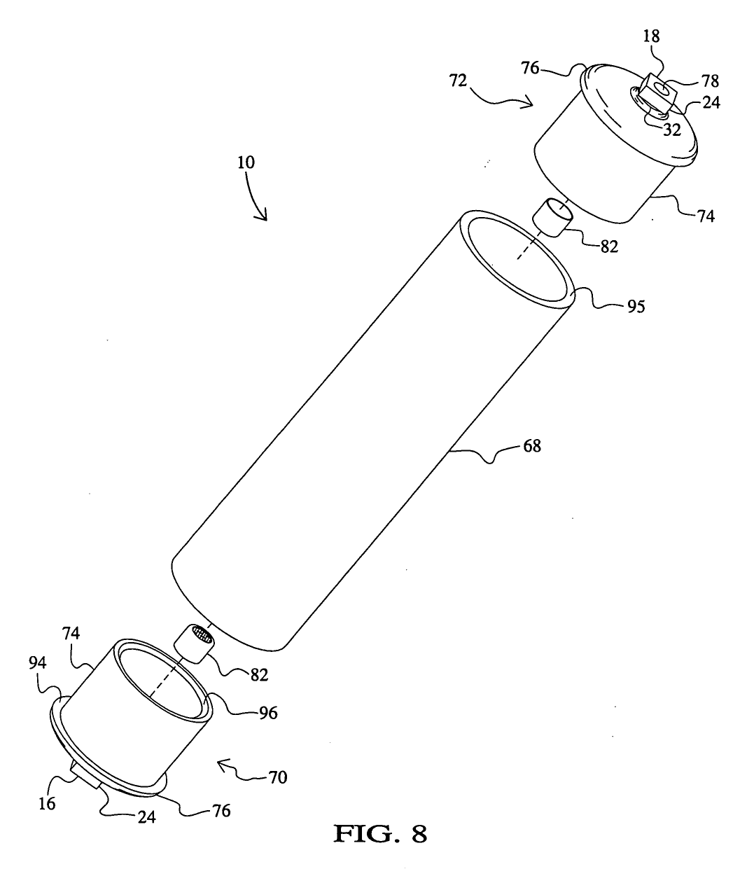

It will be appreciated that the main body 12 of the dryer 10 can be formed according to a variety of alternative construction techniques. For example, the main body 12 could potentially be made as a single closed-ended component using a blow molding technique or the like. The main body 12 can also be made using a two-component construction. According to one such construction, a tube formed with an integral closure at one end could have its other end closed by mounting an end cap. Alternatively, two tubes that are integrally closed at one end could be secured together at their respective open ends along a radial seam. Still further, two half tubes of semicircular cross-sectional shape with integral end walls at both ends could be secured together along an axial seam to form a complete closed-ended tube. Three-component constructions may also be used to form the main body 12, as exemplified by the constructions of FIGS. 4-6 and FIGS. 7-10B, respectively described below.

Turning now to FIG. 4, an exemplary construction of the dryer 10 is shown in which the main body 12 is made using standard off-the-shelf pipe components, including a central tube 38 providing a medial portion of the main body and a pair of end caps 40 and 42 respectively providing the main body's inlet and outlet ends. Although the end caps 40 and 42 are shown as being threadably mounted on the central tube 38, they could also be bonded thereto. A readily available material, such as PVC plastic piping, may be used for the components 38, 40 and 42. In this way, the dryer 10 can be made inexpensively enough to be disposable after each reasonable use.

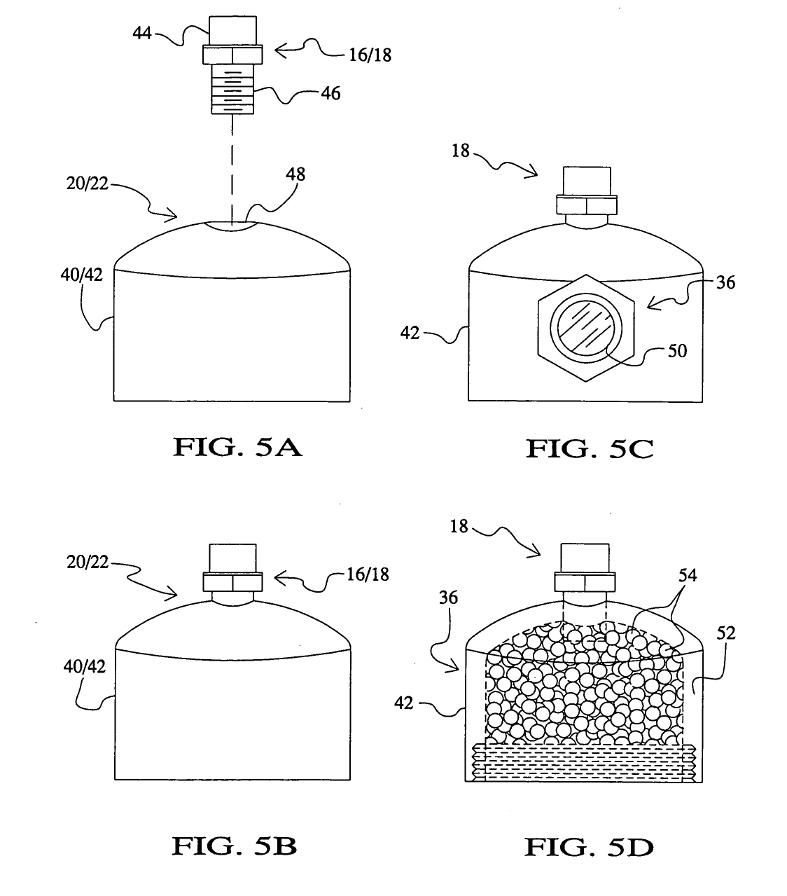

Turning now to FIGS. 5A-5B, two exemplary configuration alternatives are shown for the end caps 40 and 42 in which the design of the inlet arid outlet connectors 16 and 18 is different in each figure. In FIG. 5A, the inlet and outlet connectors 16/18 are shown as being discrete connector fittings 44 that are removably attached to the end caps 40 and 42. The connector fittings 44 have threaded ends 46 that are received in a threaded bore 48 formed in each end cap 40 and 42. In FIG. 5B, the inlet and outlet connectors 16/18 are shown as being integrally-formed on the end caps 40/42.

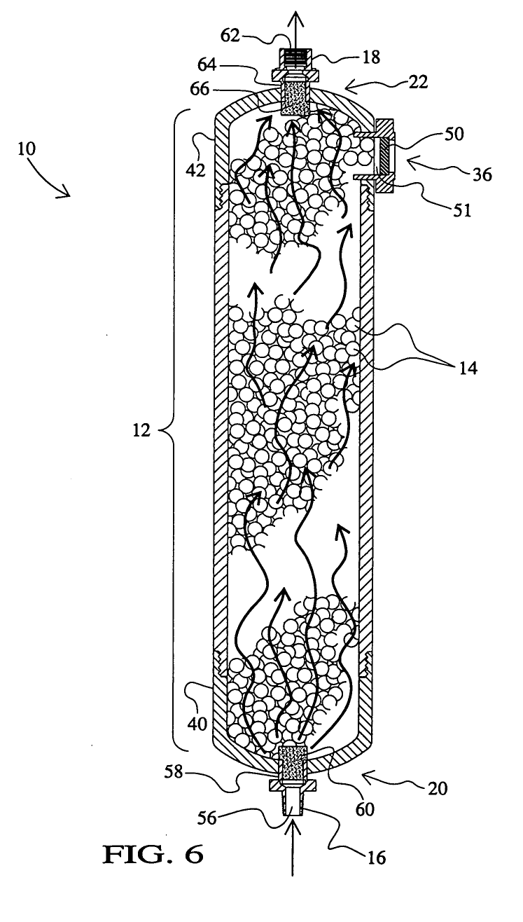

FIGS. 5C and 5D show two exemplary configuration alternatives for the end cap 42 in which the design of the dryness indicator 36 is different in each figure. In FIG. 5C, the dryness indicator 36 is constructed as a conventional site glass fitting that is threadably mounted in a threaded bore extending through the side of the end cap 42. A view port 50 provides visual access to a dryness indicating material disposed within the dryer 10. As shown in FIG. 6, the dryness indicating material may be conventionally provided by a moisture sensitive paper element 51 that changes color according to the amount of moisture present within the dryer 10; A color-changing desiccant could be used in lieu of the paper element 51. In FIG. 5D, the dryness indicator 36 is provided by virtue of the end cap 42 being transparent or translucent and a dryness indicating material 54, such as a color changing desiccant, being disposed within the end cap so as to be viewable through the transparent or translucent material. In either installation (e.g., FIGS. 5C or 5D), the dryness indicator 36 will provide a visual indication of the ability of the dryer 10 to dry a compressed air/gas stream. If a dryness-indicating material such as a cobalt-based color-changing desiccant is used, this material will have a deep blue color when the air or gas is dry, thus signifying that the dryer 10 is fully functional. When the dryer 10 is spent and the air or gas passing therethrough is not sufficiently dried, the color of the desiccant will change to light pink or clear, thereby indicating that the dryer needs to be replaced.

FIG. 6 illustrates further details of the dryer construction of FIG. 4, as well as the manner in which air/gas flows through the dryer during operation thereof. The inlet connector 16 has an internal through-bore 56 that allows the air/gas flow to pass into the hollow interior of the main body 12, which is substantially filled with the drying composition 14 (for ease of illustration, only discrete portions of the drying composition are shown). An axially interior portion of the through-bore 56 widens to define a filter-receiving chamber 58 in which is seated a filter element 60 for trapping and removing unwanted material from the compressed air/gas stream, such as oil, liquid water and particulate debris (e.g., dirt, dust, pipe scale, compressor wear particles, etc.). The filter element 60 can be made from any suitable filtering medium capable of filtering down to a desired particle size, such as approximately, 0.1 microns or below. The filter element 60 also serves to retain the drying composition 14 within the main body 12. If the filter element 60 is not used, retention of the drying composition 14 could be provided by a screen or other porous barrier (not shown). At the other end of the main body 12, the outlet connector 18 is similarly constructed with an internal through-bore 62. An axially interior portion of the through-bore 62 widens to define a filter-receiving chamber 64 in which is seated a filter element 66. This filter element performs an after-filter function that primarily removes particulates introduced into the air/gas stream by the drying composition 14, such as desiccant dust.

It will be appreciated that the filter elements 60 and 66 represent only one of several filter designs that could be used in the dryer 10. Other filters, such as pads that are stuffed (or otherwise placed) into the ends of the main body 12 could also be used. However, one advantage of respectively seating the filter elements 60 and 66 in the inlet and outlet connectors 16 and 18 is that the connectors and filter elements can be formed as fitting assemblies (per FIG. 5A) that are mounted to the main body 12 after it has been assembled to define a closed unitary structure.

During operation of the dryer 10, the air/gas stream enters main body 12 through the inlet connector 16, and is filtered by the filter element 60. The air/gas stream then enters the hollow interior of the main body 12, where it disperses through the drying composition 14 and is dried by way of interfacial contact therewith. After traveling the length of the main body 12, the air/gas stream passes through the filter element 66, where final filtering is performed, then exits the dryer 10 via the outlet connector 18.

The size of the main body 12 and the drying composition 14 are selected according the compressed air/gas flow requirements for the application in which the dryer 10 will be used, the nature and amount of drying composition 14 that is to be carried therein, and the optimum size and weight that a person would wish to carry about. Most air/gas-driven tools, including HVLP (High Volume, Low Pressure) paint guns, require an air/gas flow of between about 5-30 SCFM (Standard Cubic Feet per Minute). For these applications, an inside diameter of approximately 2-5 inches for the main body should not in any way restrict air/gas flow, assuming a drying composition such as desiccant beads is used and provided the size of the desiccant beads is selected to minimize unwanted pressure drop within the filter/dryer 10. If the drying composition 14 comprises desiccant beads, the average bead diameter will preferably lie in a range of approximately 0.1-0.4 inches. It will be appreciated that increasing the diameter of the desiccant beads tends to reduce the resistance to air/gas flow through the filter/dryer 10, thereby reducing pressure drop, but also reduces the amount of effective adsorbing surface area. On the other hand, decreasing the size of the desiccant beads increases the amount of adsorbing surface area, but also increases the resistance to air/gas flow, so as to increase the pressure drop through the dryer 10. The length of the main body 12 must be such as to hold a sufficient quantity of the drying composition 14 to provide sufficient drying capacity, but must not be so large as to render the dryer cumbersome or heavy. In most cases, a main body length of approximately 8-15 inches will be satisfactory. By following the foregoing design parameters, the dryer 10 should be capable of delivering a relative humidity of as low as ½% (−40 degree F. dew point) at a flow rate of 20 SCFM, with an inlet pressure of 100 psi and an outlet pressure of 90-95 psi. In a compressed air/gas system without any other drying equipment, the dryer 10 should be sufficient to enable at least 5-10 automobiles to be painted before replacement is required.

According to the dryer construction of FIG. 6, the drying composition 14 will normally be introduced into the main body 12 after the end caps 40 and 42 are mounted to the central tube 38. This can be done in any suitable manner. For example, assuming the end cap design of FIG. 5A is in use, the drying composition 14 could be poured in via one of the openings 48 that receives the inlet and outlet connectors 16 and 18, prior to installing that connector. If the inlet and outlet connectors 16 and 18 are integrally formed on the end caps 40 and 42, and if access into the main body is blocked by the filter elements 60 and 66, the drying composition 14 could be introduced via the opening that receives the dryness indicator 36, assuming the, end cap design of FIG. 5C is in use.

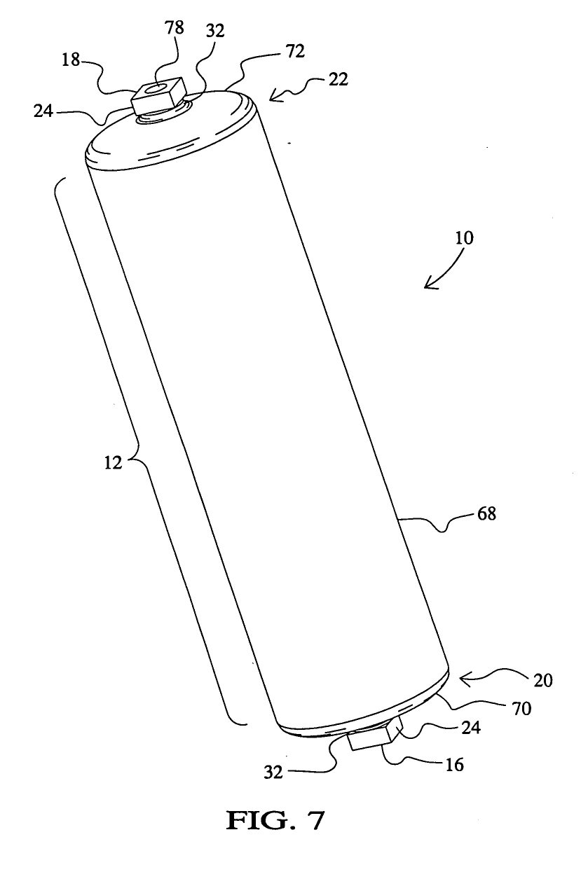

Turning now to FIGS. 7-10B, an alternative dryer construction is shown that allows the drying composition 14 to be added prior to closing the main body 12. According to this construction, the main body 12 of the dryer 10 comprises a central tube 68 and a pair of end caps 70 and 72 that are slideably inserted into the ends of the central tube. A readily available material, such as PVC plastic, may be used for the components 68, 70 and 72. The central tube 68 can be made from tube stock material, such as conventional PVC piping, or it could be molded. The end caps 70 and 72 are preferably molded.

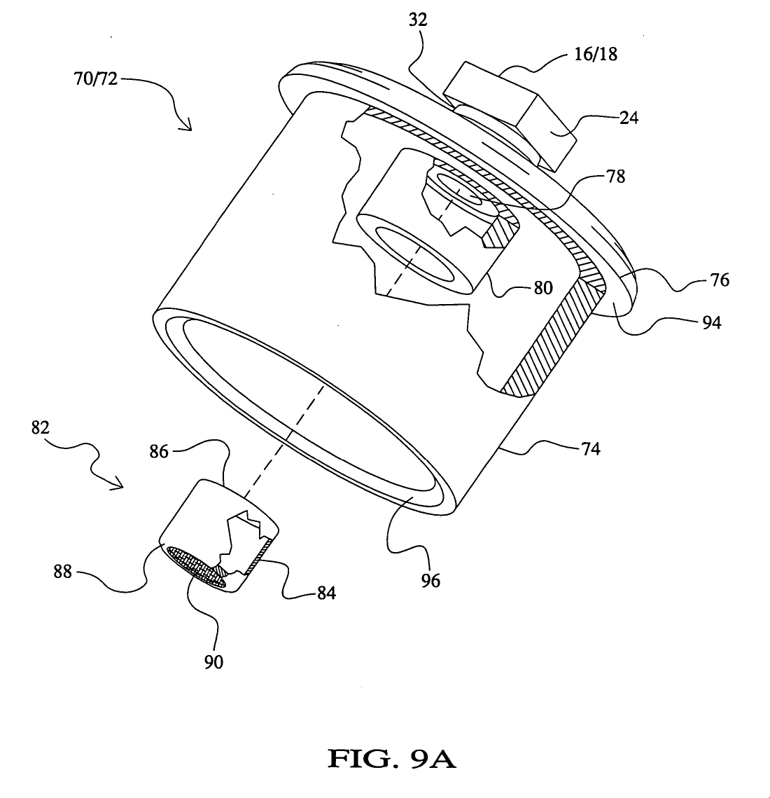

As shown in FIG. 9A, the end caps 70 and 72 each include a generally tubular portion 74 whose outside diameter is slightly less than the inside diameter of the central tube 68. The tubular portion 74 of each end cap is adapted slide into an end of the central tube 68, and to provide a large surface area for receiving a coating of adhesive, such as conventional PVC glue. The adhesive adheres the end caps 70 and 72 to the central tube and also provides an airtight seal between these components. A lip 76 formed at the base of the tubular portion 74 forms a stop that engages an associated end of the central tube 68. As shown in FIG. 9B, the lip 76 can be formed with fastener holes H1 in order to receive fasteners, such as screws S, that thread into fastener holes H2 formed in the end walls of the central tube 68. This allows the end caps 70 and 72 to be mechanically fastened to the central tube 68 in addition to being adhesively bonded thereto. Other mechanical fastening techniques, such as bayonet connections, threads, etc., could likewise be used. It should also be noted that one of the end caps 70 or 72 could be integrally formed on the central tube 68, as by molding or the like. The inlet and outlet connectors 16 and 18 are respectively integrally formed on the end caps 70 and 72, per the design of FIG. 5B. Alternatively, the inlet and outlet connectors 16 and 18 could be separately attachable fittings, per the design of FIG. 5A. Although the connectors 16 arid 18 are shown as having a female configuration, one or both connectors could be of the male variety. The use of a four-sided square nut configuration for the wrench-receiving flange 24 is also arbitrary. An internal through-bore 78 extends through each end connector 16 and 18.

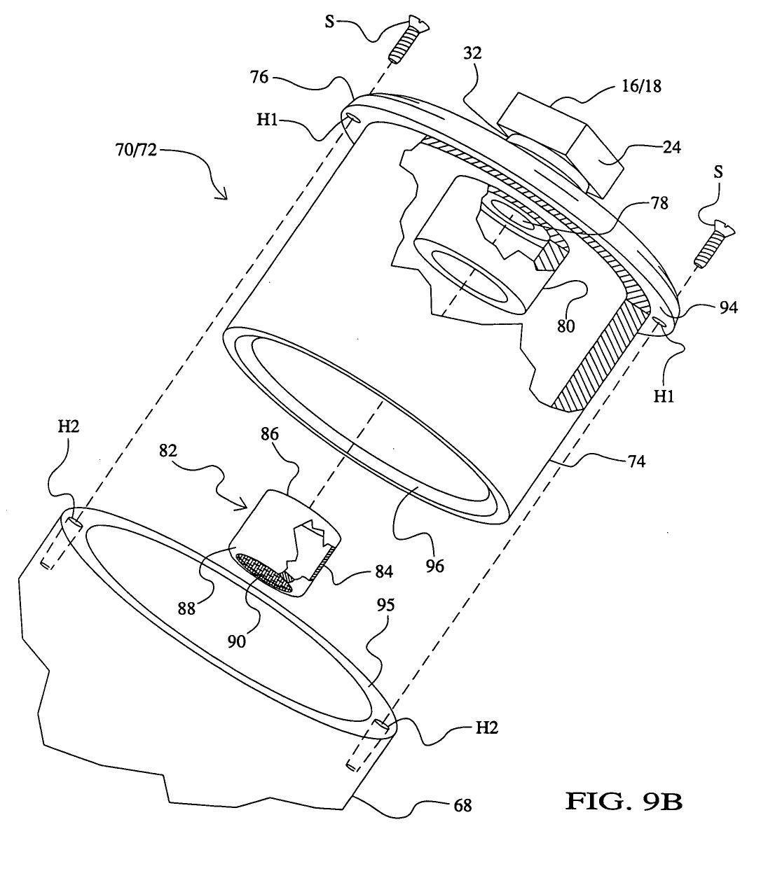

As shown in FIGS. 9A and 9B, each of connectors 16 and 18 is formed with an interior tubular boss 80 (also representing part of the integral construction of the end caps 70 and 72) whose function is to provide a filter-receiving chamber to hold a filter element 82. The filter element 82 comprises a thin tubular body 84 that is fully open at a base end 86 and which is slightly closed at a screen end 88 to mount a filter screen 90 that is introduced through the base end. The filter element body 84 is sized to be snugly received within the tubular boss 80 so that the filter screen 90 faces axially inwardly toward the interior of the dryer 10. As shown in FIGS. 10A and 10B, this arrangement defines a small air/gas plenum 92 that is in fluid communication with the through-bore 78. At the inlet side of the dryer 10, the air/gas plenum 92 aids in evenly distributing air/gas flow across the filter screen 90, thereby enabling more efficient air/gas dispersal through the drying composition 14. The filter element body 84 can be made from aluminum or other suitable material. The filter screen 90 can also be made from metal, with conventional fibrous filter material attached to one or both sides thereof. It will be appreciated that other materials could also be used. Moreover, the filter element 82 does not need to have the construction shown in FIG. 9, and could instead be a solid fibrous filter plug or the like.

Turning now to FIGS. 10A and 10B, the dryer 10 according to the construction of FIGS. 7-10B is shown being filled with the drying composition 14. In FIG. 10A, the end cap 70 has been mounted to one end of the central tube 68 and the drying composition 14 has been introduced through the opposite end to substantially fill the central tube. After optional tamping, shaking or vibrating to settle the drying composition 14, the end cap 72 (with an adhesive or other bonding agent applied to the surface of the end cap's tubular portion 74) is inserted into the central tube 68 until the underside of the lip 76 (see reference numeral 94) engages the end wall (see reference numeral 95) of the central tube, as shown in FIG. 10B. If mechanical fasteners are used according to FIG. 9B, these may now be installed. During the end cap insertion process, the drying composition 14 will easily yield to various structural elements of the end cap 72 (e.g., the tubular boss 80 and the filter screen 90), and will flow into all of the end cap's hollow interior regions. If desired, the free end of the end cap's tubular portion 74 can be beveled on its interior face, as shown at 96, to help displace the drying composition 14 away from the inside wall of the central tube 68 during the insertion process. By selecting the proper amount of the drying composition 14, substantial filling of the completed dryer 10 can be achieved, as shown in FIG. 10B, with no unfilled pockets remaining. The flow of air/gas through the dryer 10 of FIGS. 7-10B is as described above relative to FIG. 6.

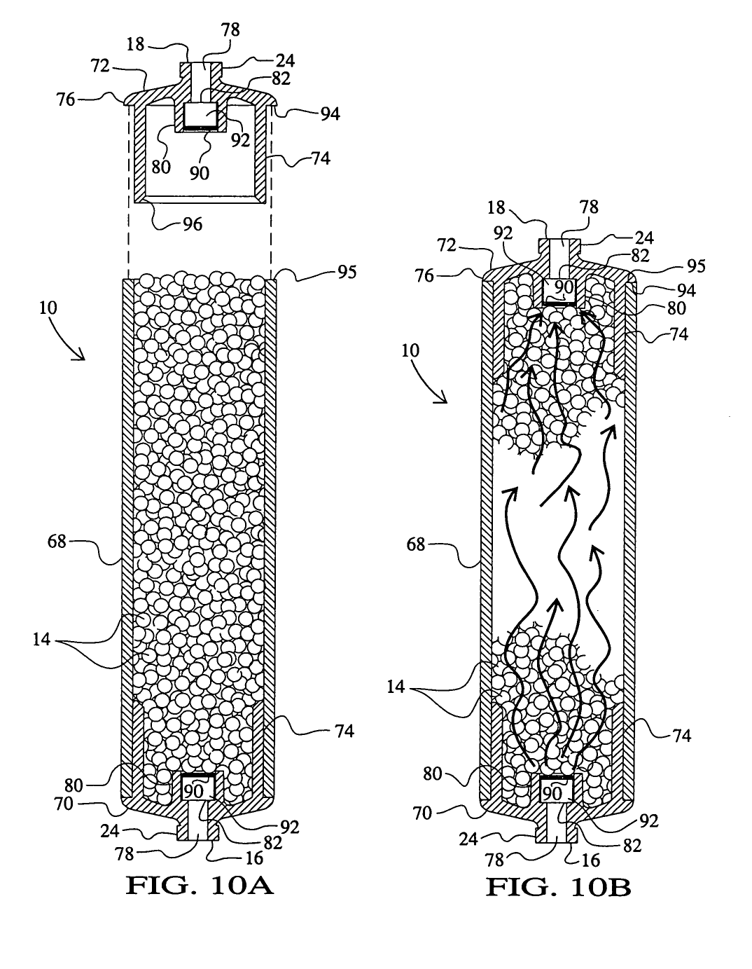

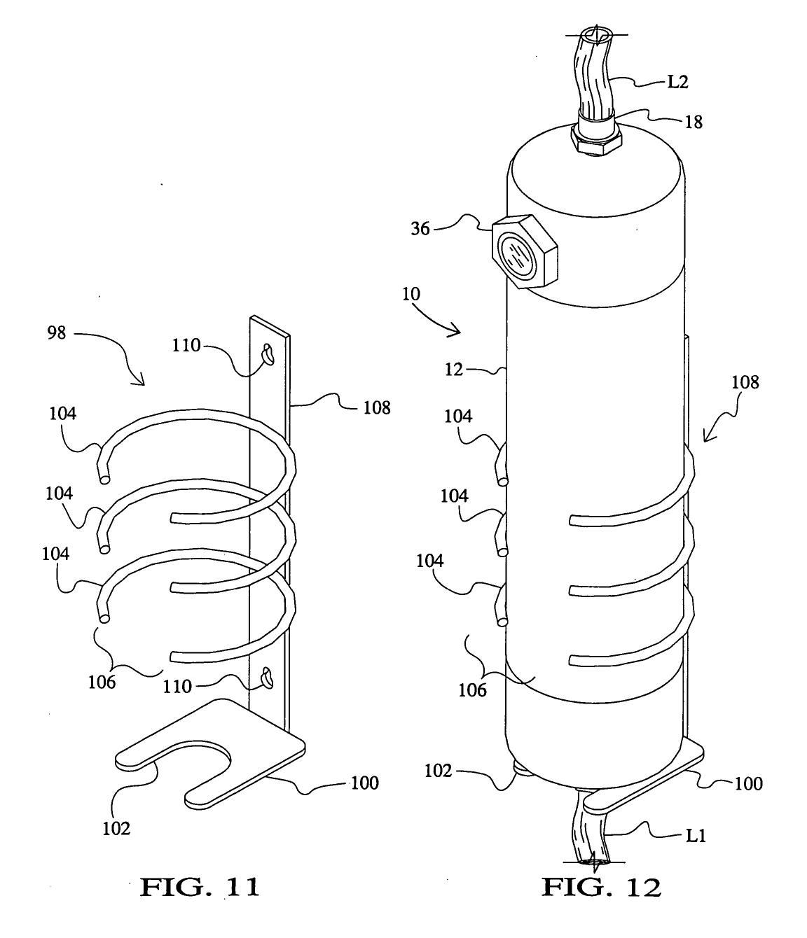

Turning now to FIGS. 11 and 12, a wall mount holder 98 may be provided that is designed to releasably mount the dryer 10 to a wall while air/gas lines are connected thereto. The wall mount holder 98 includes a lower base 100 adapted to hold one end of the dryer 10. The base 100 includes a slot 102 to accommodate whichever one of the inlet or outlet connectors 16 or 18 is placed proximate to the base. The wall mount holder 98 further includes one or more retainer members 104 above the base 100 that are adapted to engage a medial portion of the main body 12. Each of the retainer members 104 includes a gap 106 to accommodate one of the compressed air/gas hose lines “L1” or “L2” when the dryer 10 is inserted in or removed from the wall mount holder 98. A spine 108 extends upwardly from the base 100 and mounts the retainer members 104. Slotted mounting holes 110 are provided in the spine 108 for removably securing the wall mount holder 98 to a wall or other surface. The wall mount holder 98 provides a stowage accessory that may be used to stow the dryer 10 when not in use, or during use in the event that a person does not wish to wear the unit.

Accordingly, a wearable, disposable, dryer with a carrying strap and stowage accessory has been disclosed for effectively delivering dry and filtered air or gas to a compressed air/gas application. It will be seen from the various drawing figures that the dryer 10 has a simple compact configuration which allows it to be worn by a person with minimal interference during operation. The dryer 10 can be constructed inexpensively enough to be disposable after each reasonable use. Which the dryer 10 is spent (as could be definitively indicated by the dryness indicator 36), the user would simply momentarily suspend the compressed air/gas application, and replace the spent dryer with a new one before continuing operations. The exchange of one dryer 10 for another takes only moments of time. The old (spent) dryer 10 can be discarded or recycled. There is no messy drying composition replacement, no appreciable down-time, no high skill training and no high cost maintenance involved in the use of the dryer 10.

It should, of course, be understood that the description and the drawings herein are merely illustrative, and it will be apparent that various modifications, combinations and changes can be made in accordance with the invention. Moreover, although the disclosed dryer 10 has been shown in combination with a paint gun, other air/gas-driven tools, such as drills, screw drivers, staplers, nailers, die grinders, chisels, impact wrenches and ratchets, sand blasters and sanders, as well as inflation (e.g., tires) devices, could be used with a dryer constructed in accordance with the invention. As such, the invention is not to be in any way limited except in accordance with the spirit of the appended claims and their equivalents.

What is claimed is:

1. A wearable, disposable dryer for point-of-use installation in an air/gas line delivering compressed air or gas to an air/gas-driven tool, comprising:
a main body;
a drying composition substantially filling said main body;
an inlet connector on said main body;
an outlet connector on said main body; and
a carrying strap.

2. An apparatus according to claim 1, wherein said carrying strap is attached to said inlet and outlet connectors.

3. An apparatus according to claim 2, wherein said inlet and outlet connectors each comprise a strap mounting portion.

4. An apparatus according to claim 3, wherein said strap-mounting portion is defined at one end thereof by a strap retention flange.

5. An apparatus according to claim 4, wherein said strap retention flange comprises a wrench pattern.

6. An apparatus according to claim 5, wherein said strap-mounting portion is defined at a second end thereof by said main body.

7. An apparatus according to claim 6, wherein said strap comprises an opening at each end adapted to engage one of said strap mounting portions.

8. An apparatus according to claim 1, further including a dryness indicator on said main body.

9. An apparatus according to claim 8, wherein said dryness indicator comprises a site glass.

10. An apparatus according to claim 8, wherein said dryness indicator comprises a portion of said main body being transparent or translucent and a dryness indicating material in said dryer that is viewable through said transparent or translucent main body portion.

11. An apparatus according to claim 1, in combination with a wall mount holder that provides a dryer stowage accessory.

12. An apparatus according to claim 11, wherein said wall mount holder is adapted to releasably mount said dryer while air/gas lines are connected thereto during either use or non-use of said dryer.

13. An apparatus according to claim 12, wherein said wall mount holder comprises a base adapted to hold one end of said dryer, said base including a slot to accommodate one of said inlet and outlet connectors.

14. An apparatus according to claim 13, wherein said wall mount holder comprises one or more retainer members above said base adapted to engage a medial portion of said main body, each of said one or more retainer members including a gap to accommodate an air/gas line when said dryer is inserted in or removed from said wall mount holder.

15. An apparatus according to claim 1 wherein said inlet and outlet connectors are respectively disposed at first and second ends of said main body.

16. An apparatus according to claim 15 wherein said inlet and outlet connectors extend along a longitudinal centerline axis of said main body.

17. An apparatus according to claim 1 wherein said inlet and outlet connectors are removably attached to said main body.

18. An apparatus according to claim 1 wherein said inlet and outlet connectors are integrally formed on said main body.

19. A method for using a wearable, disposable dryer for point-of-use installation in an air/gas line delivering compressed air or gas to an air/gas-driven tool, comprising, in any order:
selecting a wearable, disposable dryer having a main body, a drying composition substantially filling said main body, an inlet connector on said main body, an outlet connector on said main body, and a carrying strap;
placing said carrying strap on a person;
attaching a first air/gas hose to said air inlet connector;
attaching a second air/gas hose to said air outlet connector;
operating an air/gas driven tool attached to said second air/gas hose while wearing said dryer; and
removing said strap from said person and stowing said dryer with said first and second air/gas hoses attached thereto in a wall mount holder when not in use or in the event a user does not wish to wear said dryer during use.

20. A wearable, disposable dryer for point-of-use installation in an air/gas line delivering compressed air or gas to an air/gas-driven tool, comprising:
a substantially closed main body comprising a central tube and a pair of end caps mounted to said tube;
a drying composition in said main body;
an inlet connector on one of said end caps;
an outlet connector on another of said end caps;
filter-receiving chambers respectively formed on said inlet and outlet connectors;
filter-elements seated in said filter-receiving chambers;
a dryness indicator on said main body; and
said dryer being capable of attachment to a carrying strap.
